(19) United States
(12) Patent Application Publication
(10) Pub. No.: US 2015/0343881 A1
(43) Pub. Date: Dec. 3, 2015

(54) EVAPORATIVE COOLING CYCLING USING WATER CONDENSATE FORMED IN A VAPOR-COMPRESSION A/C SYSTEM EVAPORATOR

(71) Applicant: Alliance for Sustainable Energy, LLC, Golden, CO (US)

(72) Inventors: Robert FARRINGTON, Golden, CO (US); Cory KREUTZER, Arvada, CO (US)

(21) Appl. No.: 14/723,029

(22) Filed: May 27, 2015

Related U.S. Application Data
(60) Provisional application No. 62/003,358, filed on May 27, 2014.

(51) Int. Cl. B60H 1/00; B60H 1/32

(52) U.S. Cl. CPC B60H 1/00764; B60H 1/00878; B60H 1/3202; B60H 1/3211; B60H 1/323; B60H 2001/00949

(57) ABSTRACT

The present disclosure describes systems and methods for controlling the temperature and humidity of the interior cabin of a vehicle by alternating the operation of an air conditioning (A/C) system between a first normal A/C mode of operation, whereby the cabin is cooled and condensate is formed, and a second evaporative mode of operation, whereby the cabin is cooled and humidified.

### CROSS-REFERENCE TO RELATED APPLICATIONS

This application claims priority to, and the benefit of, U.S. Provisional Patent Application No. 62/003,358, entitled “EVAPORATIVE COOLING CYCLING USING WATER CONDENSATE FORMED IN A VAPOR-COMPRESSION A/C SYSTEM EVAPORATOR” which was filed on May 27, 2014 and which is incorporated herein by reference in its entirety.

### CONTRACTUAL ORIGIN

The United States Government has rights in this invention under Contract No. DE-AC36-08GO28308 between the United States Department of Energy and Alliance for Sustainable Energy, LLC, the Manager and Operator of the National Renewable Energy Laboratory.

### BACKGROUND

The energy requirements of typical automotive air-conditioning (A/C) systems significantly increase fuel use in conventional and hybrid electric vehicles (HEVs) and significantly reduce the range of electric drive vehicles (EDVs). In many cases the range of an EDV may be decreased by as much as 30% due to nothing more than the use of it's A/C system during operation.

Current automotive air conditioning systems accumulate water condensate in the evaporator heat exchanger. Water condensation can be considered a hindrance to the reduction of air temperature across an evaporator and increases the thermal energy demand on the A/C system. As condensate accumulates on the evaporator surfaces, it begins to drain out of the evaporator, where it is removed from the A/C system through a drain line. Under typical operating conditions, this condensate is deliberately and continually removed from the A/C system as a waste stream. Once steady-state conditions are attained, an evaporator will quickly reach its maximum storage capacity and additional condensate will continue to drain from the system as long as the A/C system is operating. This continual drain of condensate represents a continual loss of energy from the A/C system.

Evaporative cooling systems have been implemented as alternatives to typical A/C systems in many situations for example, in household cooling systems. However, implementing a full evaporative cooling system for automotive applications is often impractical due to the need for a continual source of liquid water. Thus, there remains the need for improved vehicle A/C systems that either minimize energy losses due to condensate formation during normal operation or reuse the condensate formed for energy benefits.

### SUMMARY

An aspect of the present invention, is a method of cooling the interior cabin of a vehicle including the operation of an A/C system in two modes, a first mode that operates the A/C system in a substantially normal fashion, and a second evaporative cooling mode during which the A/C system is turned off or turned down. In some embodiments, the method may include operating the vehicle's air conditioning (A/C) system, while allowing water condensate to accumulate on the surface of the A/C evaporator until a first event occurs, at which point the A/C system may be turned off or turned down, for example, by stopping or slowing the flow of refrigerant through the A/C system's evaporator. The absence of refrigerant flow will result in the cessation of condensation and the eventual evaporation of the condensate, especially with the continued operation of the evaporator blower, thereby cooling the air flowing through the evaporator by evaporative cooling.

In some embodiments, an A/C system may be operated in an evaporative cooling mode until the water condensate formed during normal A/C operation is depleted. In some embodiments, operation of the normal A/C mode may be resumed upon depletion of the water condensate. In some embodiments, the A/C system may be operated until water condensate accumulates to a level that is less than the full capacity of the evaporator. In some embodiments, the A/C system may be operated until water condensate accumulates to a level that is equal to the full capacity of the evaporator. In some embodiments, the A/C system may be operated until water condensate accumulates to a level that is greater than the capacity of the evaporator.

In some embodiments, the first event may be selected from an idle-off period for the vehicle, a point where the vehicle is at a complete stop, a point where the vehicle is rapidly accelerating, a point where the vehicle is coasting, a point where the vehicle is slowing down, and/or meeting a target accumulated condensate mass in the evaporator. In some embodiments, the first event may be selected from an idle-off period for the vehicle, a point where the vehicle is rapidly accelerating, and/or meeting a target accumulated condensate mass in the evaporator. In some embodiments, the first target event may be an idle-off period for the vehicle. In some embodiments, the first event may be a point where the vehicle is rapidly accelerating. In some embodiments, the first event may be meeting a target accumulated condensate mass in the evaporator.

In a further aspect of the present invention, a method of cooling the interior cabin of a vehicle may condition the interior cabin of the vehicle by operating a typical air conditioning (A/C) system for a specified duration to allow water condensate to accumulate on the surface of the A/C system's evaporator until a first target event occurs. Once the first target is reached, the system may be switched to an evaporative cooling mode by altering or disabling the A/C refrigeration circuit, while the evaporator blower remains in operation. This mode may result in the air passing over the evaporator to evaporate the condensate present on its surfaces, resulting in the evaporative cooling of the air before it is directed to the cabin. The system may then be maintained in evaporative cooling mode for a period of time sufficient to evaporate an amount of the condensate, or until some other second target is reached, at which point the system may be switched back to the normal A/C operational mode.

In some embodiments, the conditioning system may be operated in a normal A/C mode utilizing outside makeup as a source for condensation on the evaporator to enable a target quantity of condensate to accumulate in the evaporator, to allow for subsequent evaporative cooling of the condensate. In some embodiments, the target quantity of condensate may be selected from a level that is less than the full capacity of the evaporator, a level that is equal to the full capacity of the evaporator, and/or a level that is greater than the capacity of the evaporator.

In some embodiments, the system may change the air supply that is passed over the A/C system's evaporator at the point in time when the system is switched from normal A/C mode to evaporative cooling mode. For example, at that point in time, the air supply may be switched from coming mostly from the outside environment to coming mostly from air recycled from the vehicle's cabin. In other cases, the source of air provided to the evaporator may be a mixture of outside air and air recycled from the cabin.

In some embodiments, a second target event may be selected from an idle-off period for the vehicle, a point where the vehicle is at a complete stop, a point where the vehicle is rapidly accelerating, a point where the vehicle is coasting, a point where the vehicle is slowing down, and/or meeting a target accumulated condensate mass in the evaporator. In some embodiments, the second target event may be selected from cessation of an idle-off period for the vehicle, a point where the vehicle is slowly accelerating, a point where the vehicle is coasting, and/or meeting a target reduction of condensate mass in the evaporator from evaporative cooling. In some embodiments, the second target event may be selected from cessation of an idle-off period for the vehicle, and/or meeting a target reduction of condensate mass in the evaporator from evaporative cooling. In some embodiments, the second target event may be the cessation of an idle-off period for the vehicle. In some embodiments, the second target event may be meeting a target reduction of condensate mass in the evaporator from evaporative cooling. In some embodiments, the amount of condensate evaporated during evaporative cooling mode may be from about 1% to 100% of the condensate accumulated during normal A/C mode.

In addition to the exemplary aspects and embodiments described above, further aspects and embodiments will become apparent by reference to the drawings and by study of the following descriptions.

### BRIEF DESCRIPTION OF THE DRAWINGS

Various embodiments are illustrated in referenced figures of the drawings. It is intended that the embodiments and figures disclosed herein are to be considered illustrative rather than limiting. Those skilled in the art will understand that the drawings, described herein, are for illustration purposes only. The drawings are not intended to limit the scope of the present disclosure.

FIG. 1 illustrates an evaporator in a vapor-compression A/C system under normal operation.

FIG. 2 illustrates condensate formation in an individual flow channel surface on the air-side of a vapor-compression A/C system evaporator heat exchanger.

FIG. 3 illustrates an embodiment of an evaporative cooling operation provided by the present disclosure.

FIG. 4 illustrates another embodiment of an evaporative cooling operation in an individual flow channel surface on the air-side of an evaporator heat exchanger.

FIG. 5 illustrates an example of operation cycling between the typical functioning of a vapor-compression A/C system and evaporative cooling operations, as provided by the present disclosure.

FIG. 6 illustrates one embodiment of a strategy for implementing an evaporative cooling operation according to the present disclosure.

FIG. 7 illustrates another embodiment of a strategy for implementing an evaporative cooling operation according to the present disclosure.

FIG. 8 depicts an embodiment of a system provided by the present disclosure, operating in A/C mode and bringing in air from outside of the vehicle cabin.

FIG. 9 depicts an embodiment of a system provided by the present disclosure, operating in evaporative cooling mode and bringing in air from outside of the vehicle cabin.

FIG. 10 provides an operational schematic by which some embodiments of systems provided by the present disclosure may be cycled back and forth between A/C operation and evaporative cooling operation.

FIG. 11 is a graph representing operation of a closed-system device in evaporative cooling mode at 300 Kelvin. The y-axis presents the output humidity of the air in evaporative cooling mode. The x-axis represents the ambient humidity.

FIG. 12 is another graph representing operation of a closed-system device in evaporative cooling mode at 310 Kelvin. The y-axis presents the output humidity of the air in evaporative cooling mode. The x-axis represents the ambient humidity.

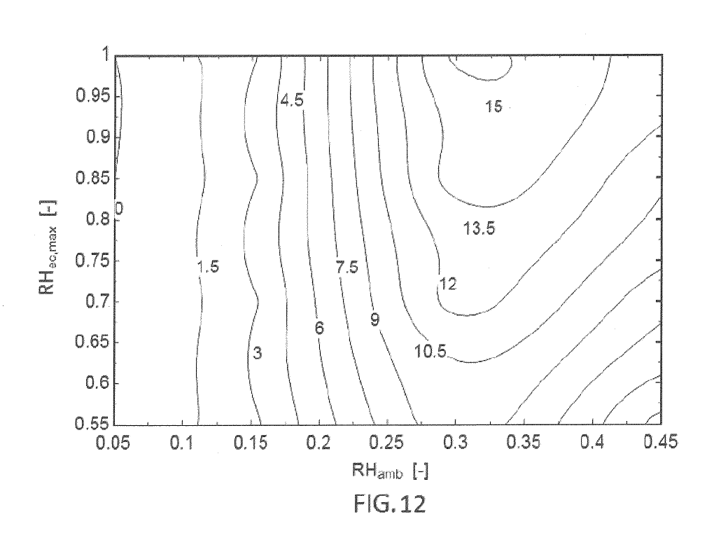

FIG. 13 is yet another graph representing operation of a closed-system device in evaporative cooling mode at 320 Kelvin. The y-axis presents the output humidity of the air in evaporative cooling mode. The x-axis represents the ambient humidity.

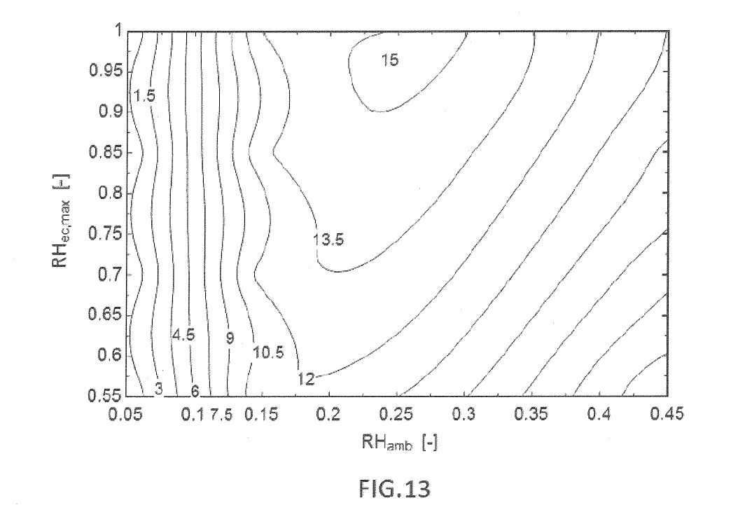

### DETAILED DESCRIPTION

The present disclosure provides systems and methods that cool the interior cabin of a vehicle by alternating the system and/or method between two modes of operation. The first mode operates an existing air conditioning (A/C) system in its normal fashion (e.g. a refrigerant vapor recompression system is operated normally), while the second mode utilizes the existing A/C system to accomplish evaporative cooling with the A/C system disabled (e.g. the refrigerant vapor recompression system is off and/or turned down, where “turned down” refers to slowing the flow of refrigerant to significantly reduce its cooling capacity). Specifically, when the system is operated in the first mode, with the A/C system running normally, the system operates as a typical automotive vapor-compression refrigeration system with supply air drawn into the vehicle from the outside and/or from the cabin and subsequently passed across/through the A/C system's evaporator. During this mode, the evaporator is supplied with a circulating, low-temperature refrigerant, which results in the transfer of energy from the air to the refrigerant to produce a cooled air stream, which is then fed to the cabin. Since the supply air is rarely completely without moisture, and because the evaporator operating temperatures often drop below at least the dew point of the supply air, water is typically condensed from the air and onto one or more surfaces of the evaporator during normal operation of the A/C system.

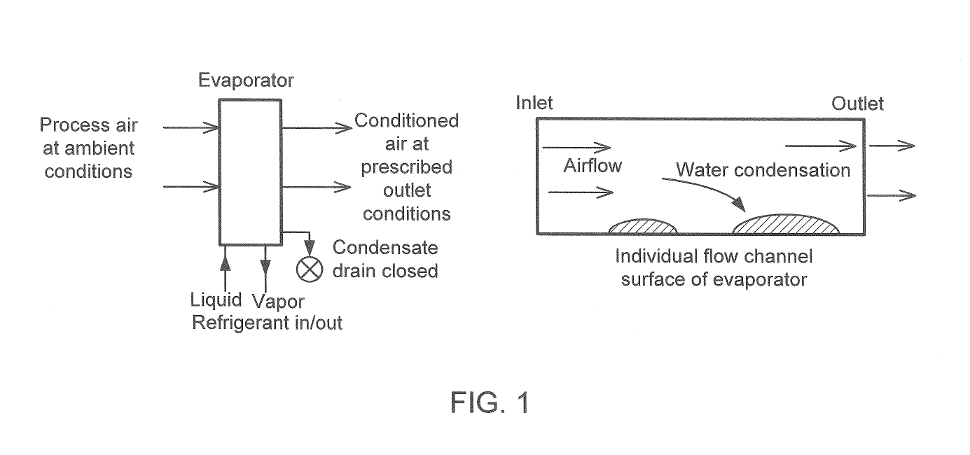

FIG. 1 illustrates the first mode of operation schematically, normal A/C operation. Ambient air (e.g. external environmental air) and/or air recycled from the cabin enters the vehicle's air ducting system and passes over the evaporator, cooling the air and condensing water from the air, which collects on the external surfaces of the evaporator. The latent heat of the condensing water and any additional sensible heat from the air and condensate are transferred to a liquid refrigerant that is flowing through the evaporator. This energy transfer results in at least a partial vaporization of the refrigerant, which then exits the evaporator on its way to the A/C system's compressor. The water condensate collects on the evaporator's exterior surfaces, and once the surfaces reach their holding capacity, drains from the evaporator surfaces through a drain line and/or valve, typically to a condensate pan (not shown).

During the second mode of operation, the evaporative cooling mode, the A/C system is disabled or at least significantly turned down, so that the cabin of the vehicle is predominantly, if not completely, cooled through the evaporation of the water condensate collected on the evaporator surfaces, that accumulated during the operation of the first mode. In some examples, the accumulated condensate on the one or more evaporators, and their associated surfaces, may evaporate due to energy supplied by the active flow of air over the condensate, with the active airflow supplied by the A/C system's blower or fan.

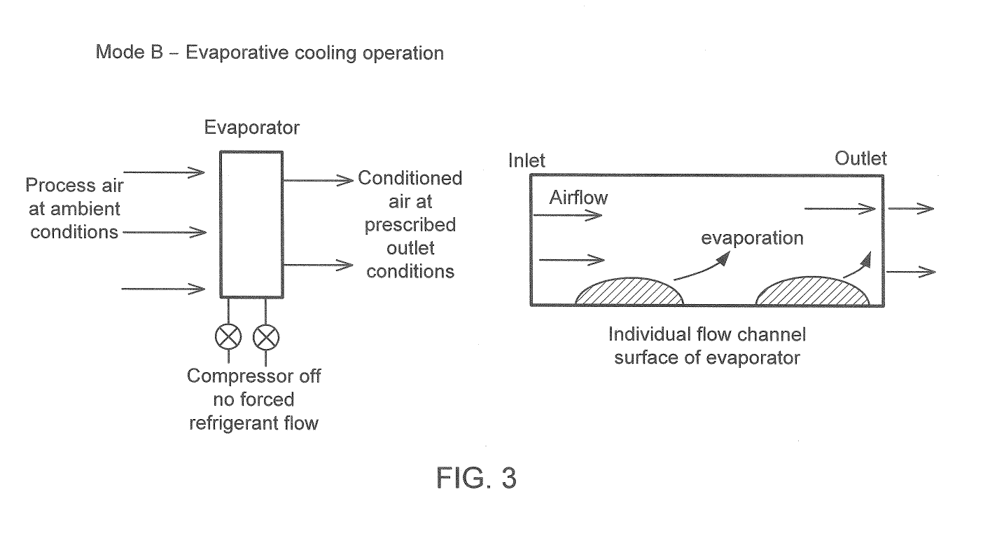

FIG. 3 illustrates the second mode of operation, the evaporative cooling mode, in more detail schematically. In this mode, the evaporator's flow of refrigerant has been set to zero by closing valves in the refrigerant's supply and return lines. Without refrigerant flow, the evaporator cannot function as a normal counter-current and/or co-current heat exchanger and will begin to warm up and approach the temperature of the incoming ambient air. However, the incoming supply air, if not already saturated, will have the capacity to receive water vapor from the condensate accumulated on the evaporator surfaces. The air then transfers the latent energy to the condensate, resulting in the formation of water vapor. In the process, the air cools and humidifies before being directed to the vehicle's cabin.

In some embodiments of the present invention, the system and/or method of cooling the cabin includes repeatedly alternating between the two modes of operation described above. For example, a cycle may begin with the first mode, with normal A/C operation, to cool the vehicle's cabin while simultaneously condensing water moisture from the outside environment and/or from the vehicle's cabin onto surfaces of the evaporator. After a first period of time, the system may then be switched to the second mode, evaporative cooling with the A/C system off and/or turned down, to cause evaporation of the accumulated condensate into the supply air, resulting in evaporative cooling of the supply air. After a second period of time, the system may be switched back to the first mode, and this process of alternating between modes may be repeated indefinitely as needed to sufficiently cool the vehicle's cabin. In other words, the A/C refrigeration system may be cycled between periods of actively running the refrigeration system and where the refrigeration is off or turned down, resulting in corresponding periods of condensing and periods of evaporating, respectively.

In some embodiments of the present invention, a system and/or method provides cooling to a vehicle and/or a vehicle's cabin by operating an A/C system in a cyclical fashion with two distinct operating modes, as follows:

Mode 1: Typical A/C system operation for a specified duration where water condensate is accumulated on at least one surface of the A/C system's evaporator and air cooling is provided by running the A/C's refrigeration system; and

Mode 2: The A/C system's refrigeration circuit is turned off, disabled, and/or turned down, and air cooling is provided by evaporative cooling. This is accomplished by drawing the air into and through the evaporator using the A/C system's blower and/or fan, whereby the condensate collected during Mode 1 is evaporated and the air is cooled.

In some embodiments of the present invention, the systems and/or methods for providing cooled air to the vehicle's cabin, utilizing the two operating modes, do so from the existing vehicle A/C systems that are currently in the automotive marketplace, with no change in mechanical design. In some cases, only minor modifications to the control and sensing systems may be necessary. In other cases, the systems and/or methods described herein may require changes and/or additions to the A/C system control strategy and/or the addition of a humidity and/or temperature sensor located upstream of the evaporator.

In another example, a method and/or system for cooling the interior cabin of a vehicle may include:

1. Performing climate conditioning of the interior cabin of the vehicle using typical A/C system operation for a specified duration to allow water condensate to accumulate on the surface of the evaporator (operating Mode #1), a) providing a sufficient amount of outside air into the A/C system to allow a target quantity of condensate to accumulate in the evaporator, or b) until a first target event occurs;

2. When a) and/or b) occurs, switching the system operation to evaporative cooling of the air passing through the evaporator, while the evaporator blower remains in operation, by altering or disabling the A/C refrigeration circuit using automated methods (operating Mode #2), with the option of changing the amount of air entering from the outside;

3. Operating the system in Mode #2 for a period of time sufficient to evaporate at least a portion of the condensate, resulting in the evaporative cooling of the air being passed over the evaporator and subsequently supplied to the interior cabin; and

4. Switching the system back to operating Mode #1 using automated methods based on the occurrence of a second target event.

In some embodiments of the present invention, the amount of outside air brought into the A/C system during the first mode of operation (Mode #1) may be large enough to allow condensate to accumulate in the evaporator to a level that is less than the full capacity of the evaporator.

“Full capacity” may be defined as follows: The amount of condensate collected and/or the rate of condensation on the evaporator's surfaces may be based on the system conditions and either a empirical correlation and/or a mass balance method. For example, for a defined time interval, the condensation accumulation rate may be calculated and summed to estimate the total mass of condensate accumulated. Once the mass of the condensate is equal to or greater than some target value that was predetermined experimentally or through analysis, the system may be considered to be at “full capacity”. So for this example, less than “full capacity” may be any time prior and/or mass of condensate less than the value determined for “full capacity”.

In some other embodiments, the amount of outside air brought into the A/C system during the first mode of operation (Mode #1) may be large enough to allow condensate to accumulate in the evaporator to a level that is equal to the “full capacity” of the evaporator. In some cases, condensate may be drained from the A/C system. In other cases, the outside air fraction brought into the A/C system during the first mode of operation (Mode #1) may be large enough to allow condensate to accumulate in the evaporator to a level that is greater than the “full capacity” of the evaporator, in which case condensate will drain from the A/C system. Based on the definition above for “full capacity”, once “full capacity” is met, any additional operation of the system where condensate mass is calculated to be generated, this mass may be considered to be beyond steady-state or saturation, and will be greater than “full capacity”, and must drain from the system.

A first target event may be selected from at least one of an idle-off period for the vehicle, a point where the vehicle is at a complete stop, a point where the vehicle is rapidly accelerating, a point where the vehicle is coasting, a point where the vehicle is slowing down, and/or achieving a target accumulated condensate mass in the evaporator. In some embodiments, the first target event may be selected from at least one of an idle-off period for the vehicle, a point where the vehicle is rapidly accelerating, and/or achieving a target accumulated condensate mass in the evaporator. In some embodiments, the first target event may be an idle-off period for the vehicle. In some embodiments, the first target event may be a point where the vehicle is rapidly accelerating. In some embodiments, the first target event may be achieving a target accumulated condensate mass in the evaporator. For example, the first target may be achieved when the evaporator reaches a predefined “full capacity” target, as defined above.

The outside environment provides all of the air to a vehicle's cabin. However, the air in the cabin may also be recirculated. Thus, the amount of air flowing over the A/C system's evaporator can include a first amount supplied from the outside environment (e.g. makeup air), and a second amount that is recirculated and supplied from the cabin. Thus, the air flowing across the A/C system's evaporator can also be defined by a first mass fraction and/or volume fraction of air supplied from the outside environment and a second mass fraction and/or volume fraction of air that is recirculated and supplied from the cabin. These two sources of air, outside air and cabin air, provide further control variables to manipulate the vehicle's A/C system. On one extreme, substantially all of the air flowing over the evaporator, regardless of mode, may by supplied from the outside environment. On a second extreme, substantially all of the air flowing over the evaporator, regardless of mode, may by supplied from recirculated air from the cabin. In other cases, however, a combination of supply air from the outside environment and recirculated air from the cabin may be desired.

Further, the amount of air (and/or mass fraction and/or volume fraction of air) originating from the outside environment and passed over the evaporator during the first mode of operation of the system may be substantially different from the amount of air (and/or mass fraction and/or volume fraction of air) originating from the outside environment and passed over the evaporator during the second mode of operation. For example, in some situations, substantially all of the air passed over the evaporator during the second mode of operation may be recirculated air from the cabin. In other situations, the amount of air passed over the evaporator (and its external surfaces) during the second mode of operation may include both a first portion of outside air and a second portion of air recirculated from the cabin. It should be noted, that most vehicles are not airtight. Therefore, some outside air leakage into the cabin is usually likely.

The amount of accumulated condensate on the evaporator that may be evaporated during the second mode of operation of the cooling system may vary from about 1 mass percent to about 100 mass percent.

A second target event may be selected from at least one of the cessation of an idle-off period for the vehicle, a point where the vehicle is slowly accelerating, a point where the vehicle is coasting, and/or achieving a target reduction of condensate mass in the evaporator from evaporative cooling. The second target event may be selected from cessation of an idle-off period for the vehicle and/or achieving a target reduction of condensate mass in the evaporator from evaporative cooling. The second target event may be the cessation of an idle-off period for the vehicle. The second target event may be achieving a target reduction of condensate mass in the evaporator from evaporative cooling.

The systems and/or methods provided by the present disclosure may help to reduce the amount of fuel used for air-conditioning conventional vehicles, HEVs, EDVs, and other vehicles that rely on vapor compression cycle A/C systems. The disclosed systems and/or methods do so by using the latent energy in the condensate that is added to an air conditioning system thermal demand when the desired output temperature is below the saturation temperature of the inlet source of air. The latent heat that is transferred to the refrigerant represents an inefficiency in the A/C system as it hinders the reduction in temperature of the incoming air stream. The systems and/or methods provided by the present disclosure remove this inefficiency by utilizing the condensate for evaporative cooling of the air stream. By utilizing the condensate produced during normal A/C mode, in a subsequent evaporative cooling mode, the condensation thermal losses suffered during the A/C mode are at least partially regained during the evaporative cooling mode.

The present disclosure provides systems capable of utilizing short term evaporative cooling within existing A/C systems without the typical disadvantages associated with a full evaporative cooling system for an automotive application. In addition, the systems provided by the present disclosure provide mechanisms to reduce the energy required for an A/C system in vehicles that implement idle-off strategies including, without limitation, mild hybrid vehicles. A mild hybrid vehicle is a vehicle that uses a standard internal combustion engine but also employs a motor/generator in parallel with the engine. However, a mild hybrid vehicle can be configured in a number of ways depending on target usage, but generally they are employed to perform energy recapture during specific events such coasting or braking, and deployment of the stored energy for assisting the engine or operating the vehicle under some conditions so that the engine can be temporarily shut off. Vehicles that utilize idle-off strategies contain internal systems that shut off the engine when the vehicle is at rest, coasting or slowing down. The systems provided by the present disclosure can be utilized during those time periods to take advantage of evaporative cooling as a means of keeping the vehicle cabin cool.

### Systems and Operation

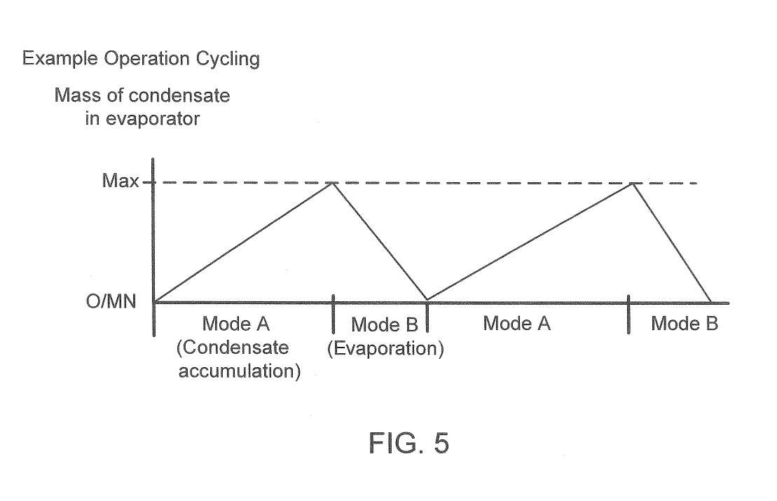

FIG. 5 illustrates an example of how a cooling system and/or method may be repeatedly cycled between A/C operation (Mode #1) and evaporative cooling operation (Mode #2. During A/C operation (Mode #1), condensate is allowed to accumulate on the evaporator surfaces until it has reached its “full capacity”, at which point the vehicle switches to evaporative cooling mode (Mode #2) to cool the air inside of the vehicle cabin. Evaporative cooling continues until no condensate is left in the evaporator. This cycling between Mode #1 and Mode #2 can continue as often as desired, or until a triggering event causes a break in the cycling shown in FIG. 5. The amount of condensate may be calculate as described above (e.g. using empirical methods and/or calculating a mass and energy balance). However, condensate levels in and/or on the evaporator may also be measure, for example by utilizing humidity probes, temperature probes, infrared sensors, conductivity probes, or any other suitable sensor or probe. Note that FIG. 5 shows accumulating and evaporation occurring at steady (linear) rates. This is shown for illustrative purposes only and other non-linear accumulation and/or evaporation rates are possible and fall within the scope of this disclosure.

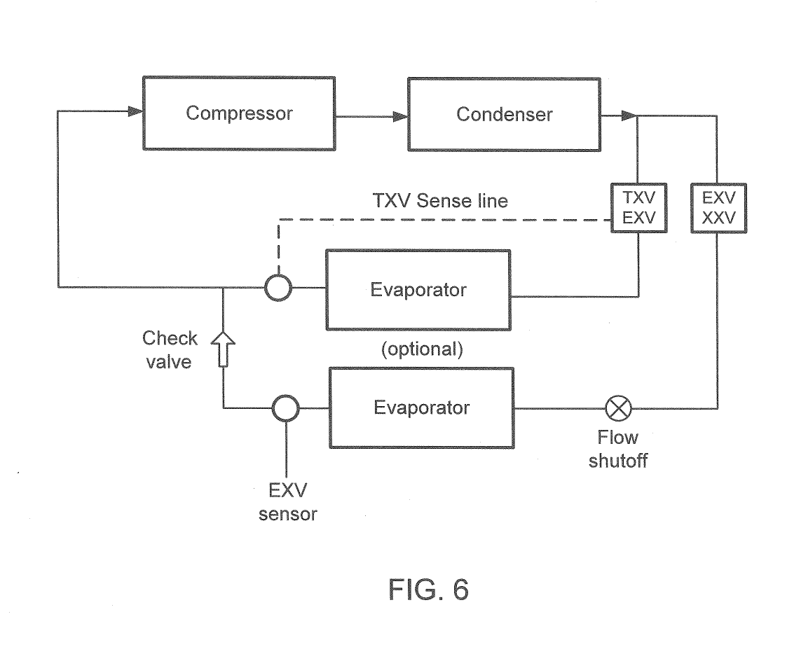

FIG. 6 illustrates a schematic view of a system provided by the present disclosure, with an optional second evaporator (the bottom evaporator in FIG. 6). In this example, a vehicle may switch between a first A/C cooling mode and a second evaporative cooling mode, as disclosed herein. However, FIG. 6 illustrates that an additional evaporator may be added in parallel to an existing A/C system, which may enable the operation of one of the evaporators in condensation mode, with the simultaneous operation of the remaining evaporator in evaporation mode. A dual evaporator system may provide a means to provide maximum system control for humidity, cooling, and efficiency. Control of these three variables (humidity, cooling, and increased efficiency due to using evaporative cooling) may be achieved with dual parallel evaporators by controlling the time spent in evaporation mode, airflow rate through each evaporator, and refrigerant flow rate through each evaporator.

So, for the example shown in FIG. 6, refrigerant may pass through the compressor to the condenser, then through a metering device (a thermal expansion valve, or TXV) and into one of the evaporators. Air conditioning may start when the refrigerant enters the compressor (typically in a low temperature and pressure, gaseous form), where it may be condensed to a high pressure-and-temperature gas. The refrigerant then enters the condenser, where it may be] condensed into a high pressure liquid. The refrigerant then enters the TXV, which may allow a portion of the refrigerant to enter the evaporator. In order for the refrigerant to cool, the flow into the evaporator may be limited to keep the pressure low and allow expansion back into the gas phase. The TXV has a sensing line that provides temperature readings to the TXV to adjust flow of refrigerant into the evaporator. An electric expansion valve (EXV) may also be provided in the A/C system as part of the normal safety operation of the A/C system. If gaseous refrigerant is detected by the EXV, the A/C system can be adjusted or shut down to prevent failure. In some embodiments of the system depicted in FIG. 6, each evaporator contains a valve that is independently selected from a TXV and an EXV.

During evaporative cooling, the stoppage of refrigerant flow depends on the HVAC control strategy implemented for the various depicted hardware components (EXV, TXV, electric compressor, mechanical compressor, among others). In the embodiment depicted in FIG. 6, a second evaporator is present in the system, though as indicated this second evaporator is optional and is not required to implement the system depicted in FIG. 6.

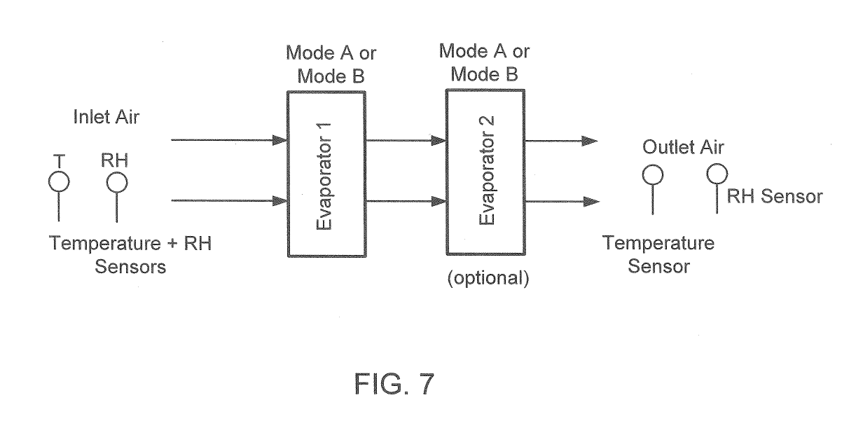

FIG. 7 provides an airside flow diagram of the system depicted in FIG. 6. Air to be conditioned (“inlet” air) is brought into contact with a temperature sensor and a relative humidity sensor before entering the first evaporator (Evaporator 1). The sensors measure the inlet air properties, providing information relating to the temperature and relative humidity information of the inlet air to the vehicle. Once the air has passed through the evaporator, the conditioned air (“outlet air”) is brought into contact with another temperature sensor and relative humidity sensor, which allows the vehicle's climate control system to determine whether or not the air leaving the evaporator is at the desired temperature and humidity before it is directed to the vehicle cabin.

During evaporative cooling, it may be desirable to have the option to stop the evaporative cooling cycle once the relative humidity of the cabin reaches a set maximum, for example, to maintain a desired comfort level within the vehicle cabin. Referring again to FIG. 7, a system and/or method could be operated so that the initial relative humidity of the air in the cabin is at a low target value at the beginning of the evaporative cooling mode. Then, eventually during operation of the system in evaporative cooling mode, a maximum desired humidity level may be attained, at which point the system may then be switched to the active A/C mode of operation. Operation of the A/C mode may then reduce the moisture in the cabin air by condensation on the evaporator, until the initial low target humidity value is re-attained, at which point the system may be switched back to the evaporative cooling mode. This cyclical switching between the two modes of operation may be repeated as many times as needed. FIG. 7 illustrates an example where, during evaporative cooling, the inlet air is solely recycled from the cabin, with no intentional introduction of external air into the system. In other cases, however, air from the cabin of the vehicle may be mixed with outside air before it is directed to the evaporator.

To get a maximum benefit from evaporative cooling, it may be desirable to obtain an input airstream that is lower in humidity than the ambient conditions, to help promote the evaporation of accumulated condensate from the evaporator. In an automotive system, a dehumidified air stream that may be available is air from within the cabin, this air having been at least somewhat dehumidified and made available by recirculating that air to the evaporator. This airstream is temporary for evaporative cooling as the humidity in recirculation mode will rapidly approach saturation. The embodiments of evaporative cooling and automated control of recirculation shown in FIGS. 6 and 7 may be advantageous in vehicle systems where the system/car is shut off during stopping on an intermittent basis such as, for example, vehicles that employ idle-off strategies. In addition, the embodiments of FIGS. 6 and 7 may be advantageous in mechanically driven systems, to provide temporary cooling at undesirable engine speeds.

For operation with evaporative cooling and automatic control over recirculation air, the examples illustrated in FIGS. 6 and 7 need not be modified from typical, current A/C system designs. Instead, they would only require a change in control strategy and potentially the addition of at least one relative humidity sensor.

As noted above, the use of only recirculated air from the vehicle cabin as a dehumidified air stream may only be temporary in nature, when operating the system in evaporative cooling mode. In order to prolong the time in which evaporative cooling may occur, the moisture in the recirculating air may be diluted with outside air and the cabin air's humidity reduced, provided the outside environment has a lower humidity level than the recirculated inside air.

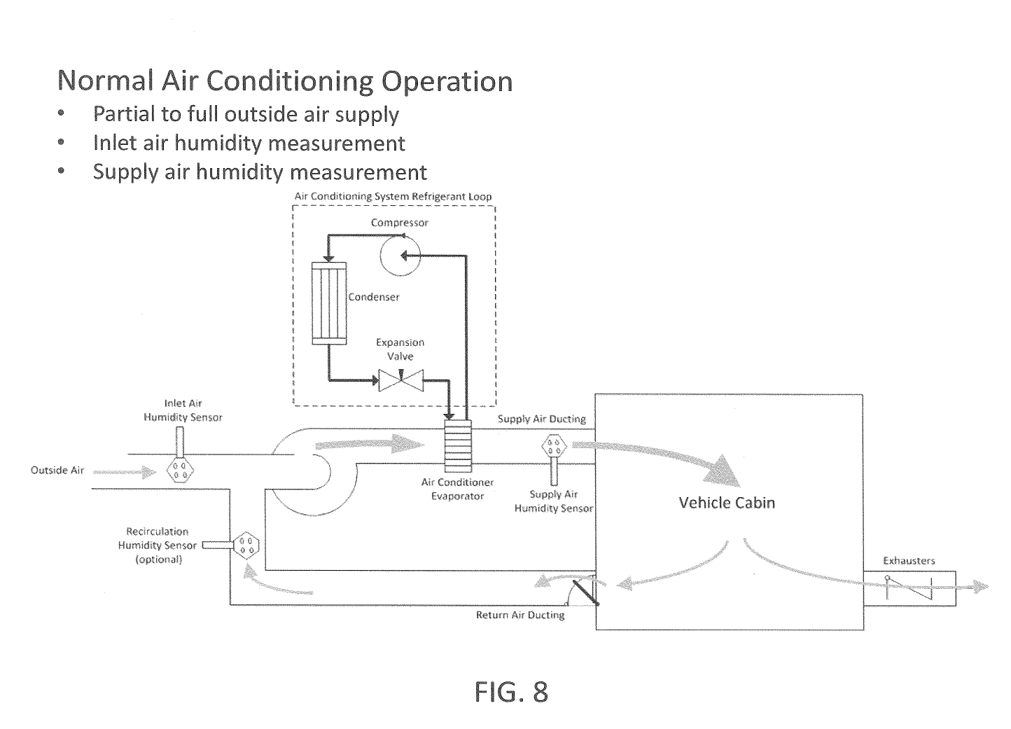

FIG. 8 illustrates another example of a system for providing cooling to the cabin of a vehicle. In this case, some amount of outside air may be brought into the cooling system while operating in A/C mode. At least one humidity sensor may be positioned air inlet that provides outside air to the system, to monitor the relative humidity of the incoming air. In addition, at least one humidity sensor may be positioned between the evaporator and the point of entry into the cabin of the vehicle. Also, another humidity sensor may be positioned between the point at which air is removed from the cabin to be directed back to the evaporator as recirculated air.

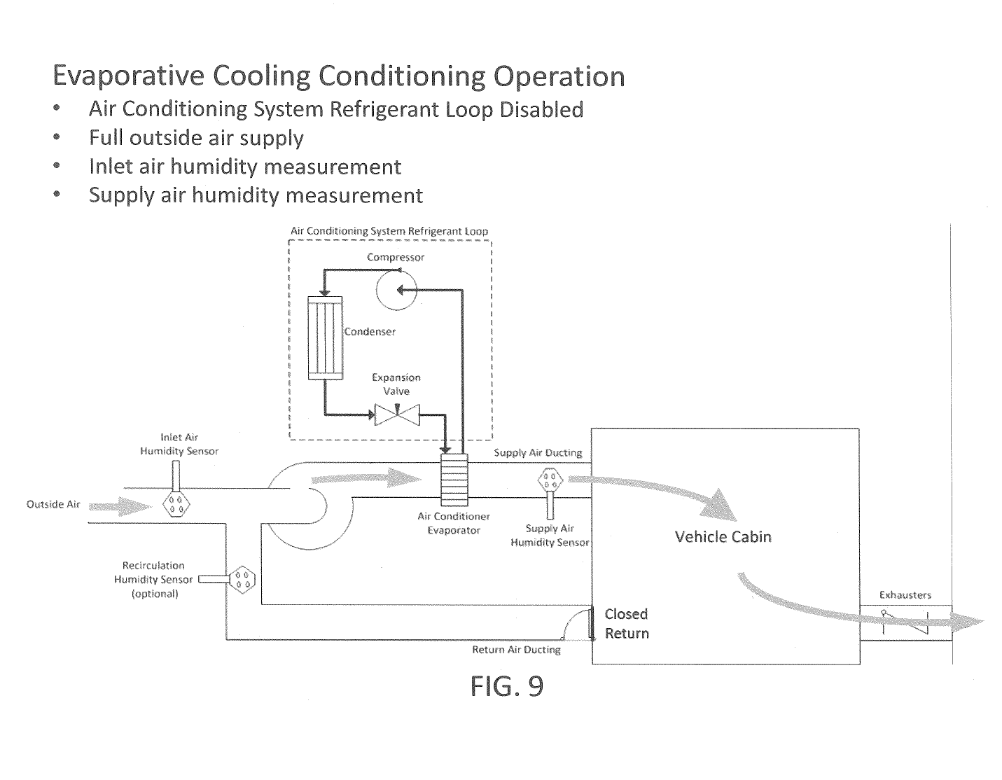

FIG. 9 illustrates yet another example of a system for providing cooling to the cabin of a vehicle. In this case, at least some outside air is brought into the cooling system while operating in the evaporative cooling mode. However, unlike the example illustrated in FIG. 8, this example shows a case where no air is recycled from the vehicle cabin to the evaporator. Instead, in this case, all of the air provided to the evaporator during operation of the evaporative cooling mode is outside air. The same humidity sensors are shown in FIG. 9 as in FIG. 8, although the number and placement of humidity sensors may vary depending on the application.

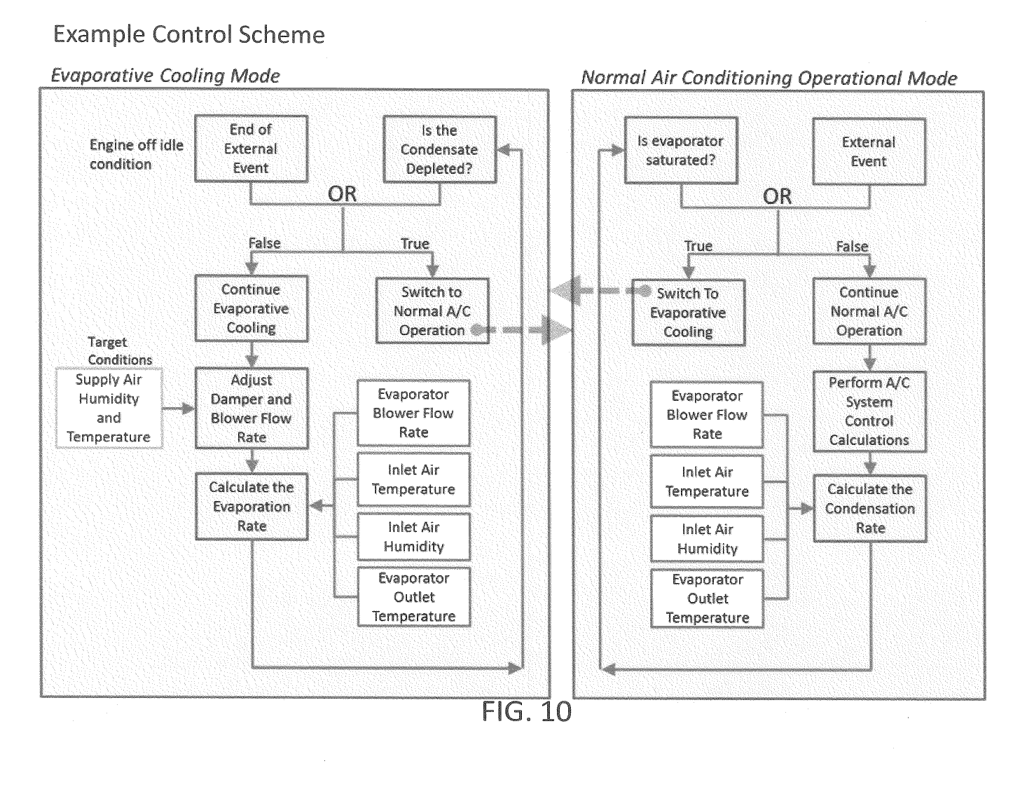

FIG. 10 illustrates exemplary flow diagrams of how to construct a control system for an A/C system that utilizes a first, normal air conditioning mode, and a second, evaporative cooling mode, and how to cycle between these two modes of operation. Operation during evaporative cooling mode is shown in the left hand panel and the normal A/C mode is shown on the right. Examples of operating conditions that trigger the switch between operational modes are provided.

Referring to FIG. 10, an exemplary method may be as follows. The user starts the vehicle and the A/C system. This places the system in the normal air conditioning mode—the block on the right. Because no condensate has yet been collected, and no external event such as an idle-off event has occurred, the “OR” condition is “false”, normal A/C operation commences. The HVAC system controller obtains the evaporator blower flow rate, inlet air temperature, inlet air humidity, and evaporator outlet temperature. Then, using either a look-up table or mass balance algorithm, the controller determines the rate of condensate collected in the evaporator and calculates the condensate mass collected for a set amount of time (for example, the system could perform this evaluation at 10 Hz, so the rate would be multiplied by 100 ms). The control system then checks to determine whether or not the evaporator has reached “full capacity” based on a predetermined “full capacity” value stored in the HVAC system controller. If the evaporator is not at “full capacity” and/or an external event has not occurred, the system remains in normal A/C operational mode, and until the control system detects a “full capacity” state and/or a target event is reached.

For example, assume that an idle-off event occurs and the previous iteration of the control system identified the evaporator to be at 80% of “full capacity”. The idle-off event is an external event that triggers the system to switch to the evaporative cooling mode (the left control block of FIG. 10). Now, at 80% of “full capacity”, there is adequate starting condensate, so the “OR” condition for the evaporative cooling mode (left block) evaluates to “True”. The HVAC system controller then obtains the evaporator blower flow rate, inlet air temperature, inlet air humidity, and evaporator outlet temperature and using either a look-up method or mass balance algorithm, calculates the rate of condensate depletion, and the desired system settings to meet target outlet humidity and temperatures (these may be factory settings). The HVAC system controller then modifies the system to meet the calculated conditions, and checks to see if the condensate has been depleted. At the end of this external event, the system may be switched back to normal air conditioning mode, so that the system may once again begin to store condensate, for the next cycle back to the evaporative cooling mode.

### Advantages Provided by the Disclosed Systems

Systems provided by the present disclosure will significantly reduce the total amount of fuel consumption required to power automotive A/C systems. The disclosed systems modify the control system of a typical automotive system A/C to take advantage of evaporative cooling by utilizing the condensate formed during normal operation of the A/C system, in a second evaporative cooling mode.

Reducing A/C energy use (liquid fuel or electric battery) is a very active field in the automotive industry. Systems provided by the present disclosure provide for the full or partial recovery of the added thermal energy demand on an A/C system from water condensation by providing cooling through evaporation of the accumulated condensate.

Water condensation inside of an A/C system is a serious disadvantage to the thermal operational efficiency of a vehicle. This is because water (condensate) accumulation inside of the evaporator reduces the total amount of heat transfer from the air to the coolant, which in turn hinders the reduction of air temperature across an evaporator and increases the thermal energy demand on the A/C system. By implementing the systems provided herein, the condensate accumulated in an evaporator that has been traditionally viewed as a negative may now be viewed as a storage mechanism that may be used to the vehicle's, and vehicle operator's, advantage.

Current A/C systems may be quickly modified to adopt the operational strategies disclosed herein. In addition, new optimized A/C systems may be designed for it, without the need to engage in a significant redesign of those systems. The methods and systems described herein, may have the immediate impact of reducing the fuel used for HEVs by increasing engine off time (particularly for start/stop strategies) and increasing the range of EDVs by reducing battery usage for operating the A/C compressor. Systems provided by the present disclosure may also be applied to conventional vehicles that face increasing fuel economy standards. The disclosed systems present minimal costs for modifying existing A/C systems and will not impact vehicle reliability. In some embodiments, route-based control systems for vehicles utilizing the systems provided by the present disclosure will lead to better vehicle performance by disengaging the A/C compressor during certain events including, for example, hard accelerations or hill climbing, while still providing cooling to the interior cabin of the vehicle. (Route based control systems have a knowledge of the upcoming terrain before it occurs. For instance, if the vehicle knows it will be going downhill for the next 0.5 mile, it can optimize itself for coasting and deceleration and store some of the energy rather than dissipating it through normal braking)

Systems provided by the present disclosure may improve preexisting technology and may be implemented with current manufacturing practices and materials for existing automotive A/C systems. There may be no need to change the manner in which the automotive industry manufactures vehicles in order to implement the strategies disclosed herein. In some embodiments, only a change in the control strategy (i.e., the control algorithms embedded in automotive A/C system control hardware) is needed. In some examples, additional A/C components may be used and installed in a vehicle. Such components may include, for example, optimizing the evaporator design for evaporative cooling, adding one or more relative humidity sensors downstream from an evaporator, and/or adding one or more temperature sensors downstream of the evaporator.

The systems provided by the present disclosure are inexpensive to implement, but can have significant impacts on improving fuel economy and/or electric range. The disclosed systems will benefit automotive manufacturers by assisting them in meeting higher Federal Corporate Average Fuel Economy Standards and stricter tailpipe emission requirements.

### Operation in A/C Mode

FIG. 1 provides a view of the operation of an embodiment of an evaporator within a system provided by the present disclosure, operating in A/C mode. As shown in FIG. 1, the air to be treated or cooled (“process” air) is brought into the evaporator at ambient conditions (e.g. external environmental conditions). During normal A/C operation mode, the temperature of the air flowing through the evaporator is reduced by transferring heat from the air to the evaporator, utilizing refrigerant. The process air brought into the evaporator is therefore actively cooled by heat exchange with the refrigerant. Upon leaving the evaporator, the now conditioned air is transported away from the evaporator and into the cabin of the vehicle, for example by a blower or fan. In the embodiment shown in FIG. 1, during normal A/C mode, a condensate drain in the evaporator may be closed to allow condensate to accumulate inside of the evaporator chamber, pan, and/or tray, and/or on the various outside surfaces of the evaporator. In this fashion, water may be condensed out of the air stream and onto the automotive air conditioning system evaporator, for a wide range of ambient conditions and magnitudes of heat transfer into a vehicle cabin.

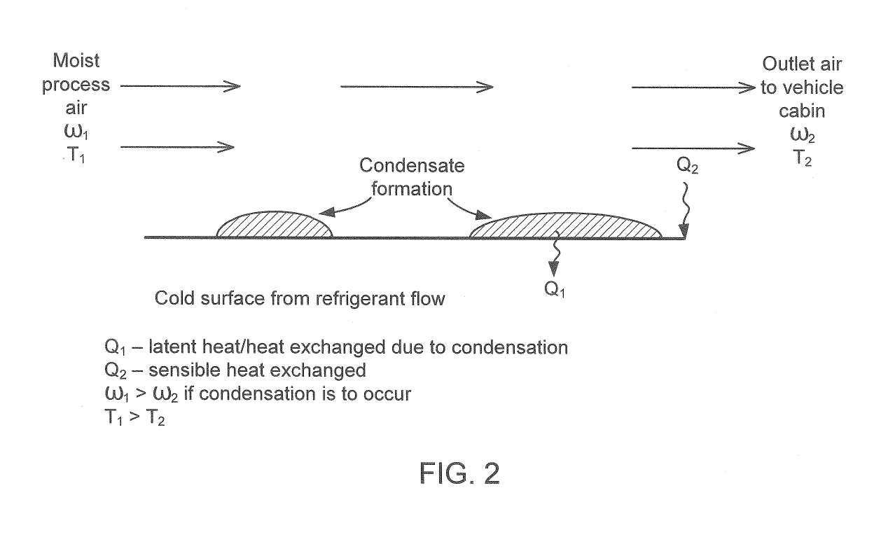

Referring to FIG. 2, the normal A/C mode results in the transfer of energy from the air to the refrigerant, through both sensible heat transfer (Q2) in cooling the air, and latent heat transfer (Q1) from the exothermic process of water condensation. As the air is cooled (FIG. 2, T1>T2), the thermodynamic equilibrium partial pressure of water vapor is reached at a given temperature (i.e., the dew point temperature of the air is reached) and any additional removal of heat from the air results in water condensation. In the example shown in FIG. 2, humidity content is reduced across the evaporator chamber during A/C operation (ω1>ω2), which indicates condensation on the cold surfaces of the evaporator chamber.

### Operation in Evaporative Cooling Mode

FIG. 3 illustrates the processes occurring during operation of the evaporative cooling mode. As shown in FIG. 3, the air to be treated or cooled (“process” air) may be brought into the evaporator at ambient conditions. During evaporative cooling operation, the temperature of the process air may be reduced by the evaporation of condensate (water) present in and/or on the evaporator into the process air. The temperature of the process air brought into the evaporator is therefore reduced through evaporation—the phase transition of liquid water (the condensate) to water vapor, which cools and humidifies the process air. Upon leaving the evaporator, the now conditioned air is moved away from the evaporator and into the cabin of the vehicle. In the embodiment shown in FIG. 3, during operation under evaporative cooling mode, the A/C compressor is turned off or turned down so that minimal or no refrigerant is flowing through the evaporator.

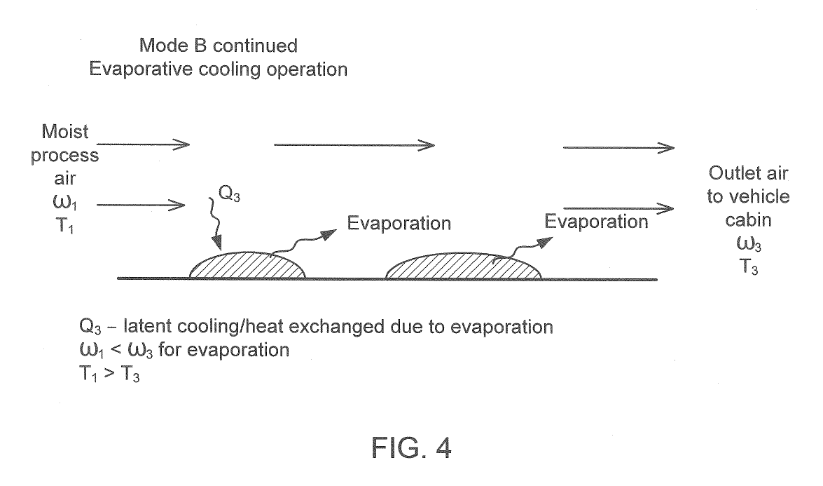

As shown in FIG. 4, during operation in evaporative cooling mode, water vapor from the condensate may be added to the process air, which lowers the temperature of the process air (T1>T3) exiting the evaporator. The energy needed to evaporate the condensate, which affects the temperature of the process air, is taken from the process air and converted into latent heat (Q3). It is this latent heat that is used to generate water vapor from the condensate. Evaporative cooling therefore requires an input of heat, which is taken from the process air, which in turn causes a drop in the temperature of process air that is proportional to the sensible heat drop from the process air and an increase in humidity proportional to the latent heat gain. In the disclosed embodiment, the humidity content is increased across the evaporator chamber during evaporative cooling operation (ω1<ω3), indicating evaporation of the condensate.

### EXAMPLES

It is noted that there are alternative ways of implementing the embodiments disclosed herein. While a number of exemplary aspects and embodiments are disclosed, those of skill in the art will recognize certain modifications, permutations, additions and sub combinations thereof. Accordingly, the disclosed embodiments are to be considered as illustrative and not restrictive.

### Example 1

Evaluation of a representative system model was performed in order to provide proof of concept test data showing the potential impact of some of the evaporative cooling concepts disclosed herein on automotive A/C system energy usage. For the evaluation, the amount of thermal energy required to meet target air temperature set points were calculated with and without the use of the evaporative cooling mode (and cycling the evaporative cooling mode with the normal A/C mode), and the results were used to calculate percent improvements over the baseline normal operating condition. Certain assumptions were made about automotive configurations to provide real-life conditions and analysis, or as close thereto as possible. For the analysis, the maximum amount of condensate that could be retained in the evaporator, relevant geometric parameters, air flow rate, and system operating conditions were determined from peer-reviewed literature on the subject for typical light-duty vehicles in addition to estimates from those skilled in the field when appropriate. The analysis included a broad range of operating conditions, including several environmental conditions, and considered a range of relative humidities for the air entering the evaporator in evaporative cooling mode.

The conditions tested are summarized in Table 1:

TABLE 1

| | | |
|---|---|---|
| M_{condensate,max} = 0.25 | [kg] | Maximum condensate mass retention in evaporator |
| A_{face} = 0.05 | [m₂] | Evaporator air-side front facial area |

Normal Operation

| | | |
|---|---|---|
| \dot{V}_{blower} = 200 | [ft₃/min] | Blower volumetric flow rate |
| P_{amb} = 101325 | [Pa] | Atmospheric pressure |
| ${\dot{V}}_{air} = {\dot{V}}_{blower} - \vert 0.000471947 \cdot \frac{m ⋀ 3 \text{/} s}{ft ⋀ 3 \text{/} min} \vert$ | | Volumetric air flow rate through the evaporator |
| Tₒᵤₜₗₑₜ = 278.15 | [K] | Evaporator air outlet temperature-can be varied |
| | | parametrically |
| RHₒᵤₜₗₑₜ = 1 | [-] | Evaporator air outlet humidity-can be varied |
| | | parametrically |
| ρ_{amb} = ρ[AirH20, T = T_{amb}, R = RH_{amb}, | | Density of air at ambient conditions (dry air mass/ |
| P = P_{amb}] | | volume of wet air) |
| \dot{M}_{air,dry} = ρ_{amb} · \dot{V}ₐᵢᵣ | | mass flow rate of dry air through the evaporator |
| ω_{amb} = ω[AirH2O, T = T_{amb}, R = RH_{amb}, | | Ambient humidity ratio property lookup, kg water/kg |
| P = P_{amb}] | | dry air |
| ωₒᵤₜₗₑₜ = ω[AirH2O, T = T_{amb}, R = RH_{amb}, | | Outlet air humidity ratio property lookup, kg water/kg |
| P = P_{amb}] | | dry air |
| \dot{m}_{condensate} = \dot{m}_{air,dry} · [ω_{amb} − ωₒᵤₜₗₑₜ] | | Calculation for the rate of condensation of water on |
| | | the evaporator |
| h_{air,amb} = h[AirH2O, T = T_{amb}, w = ω_{amb}, | | Enthalpy of air and water mixture per mass of dry air |
| P = P_{amb}] | | for ambient |
| h_{air,outlet} = h[AirH2O, T = Tₒᵤₜₗₑₜ, w = | | Enthalpy of air and water mixture per mass of dry air |
| ωₒᵤₜₗₑₜ, P = P_{amb}] | | for evaporator outlet |
| H_{fg,water} = Enthalpy_{vaporization} | | Enthalpy of vaporization of water |
| Q_{evaporator,normal} = \dot{m}_{air,dry} · [ω_{amb} − ωₒᵤₜₗₑₜ] | | Calculation of normal evaporator duty |
| Q2_{evap,normal} = \dot{m}_{air,dry} · Cp [Airₕₐ, T = T_{amb}, | | Approximation of normal evaporator duty |
| P = P_{amb}] · [T_{amb} − Tₒᵤₜₗₑₜ] + \dot{m}_{condensate} · | | |
| H_{fg,water} + \dot{m}_{air,dry} · ωₒᵤₜₗₑₜ · Cp[Steam, | | |
| T = T_{amb}, P = P_{amb]} · [T_{amb} − T_{outlet]} | | |
| ${V}_{face} = \frac{{\dot{V}}_{air}}{Aface}$ | | Calculated for comparison to compiled, known information |
| ${t}_{normal} = \frac{Mcondensate \text{,} max}{mcondensate}$ | | Time necessary for the evaporator to accumulate the maximum amount of water it can store |

Evaporative Cooling Mode

| | |
|---|---|
| ω_{ec,outlet} = ω[AirH2O, T = T_{ec,outlet}, | Outlet humidity ratio property lookup in evaporative |
| R = RH_{ec,max}, P = P_{amb}] | cooling mode |
| | Mass flow rate of water being evaporated based on |
| | ambient conditions and maximum outlet RH for EC |
| | mode |
| Q_{ec} = mₑᵥₐₚₒᵣₐₜᵢₒₙ · h_{fg,water} | Heat removed from air due to evaporation of water |
| | Heat removed from air due to evaporation of water |
| ${t}_{ec} = \frac{Mcondensate \text{,} max}{mevaporation}$ | Time necessary for the evaporator to release the full amount of water it can store through evaporative cooling |
| E_{baseline} = Q_{evaporator,normal} · [tₙₒᵣₘₐₗ + t_{ec}] | Thermal energy required for baseline operation at a |
| | maximum cycle duration |
| E_{ec,cycling} = E_{baseline} − Q_{ec} · t_{ec} | Thermal energy required for a maximum cycle |
| | duration with evaporative cooling available |
| $Improvement = 100 \cdot [ \frac{Ebaseline - Eec \text{,} cycling}{Ebaseline} ]$ | Percent improvement when utilizing evaporative cooling cycling |

A series of 64 operations were modeled. The data for each operation is summarized in Table II:

TABLE II

| | RH_{amb} | RH_{ec, max} | T_{amb} | mₑᵥₐₚₒᵣₐₜᵢₒₙ | mₑᵥₐₚₒᵣₐₜᵢₒₙ | Tₒᵤₜₗₑₜ | t_{ec} | tₙₒᵣₘₐₗ | T_{ec, outlet} | Q_{evaporator, normal} | Q_{ec} | |
|---|---|---|---|---|---|---|---|---|---|---|---|---|
| | [—] | [—] | [K] | [kg/s] | [kg/s] | [K] | [s] | [s] | [K] | [W] | [W] | Improvement |
| Run 1 | 0.05 | 0.55 | 290 | | | | | | | | | |
| Run 2 | 0.15 | 0.55 | 290 | 0.000296 | 1.00E−16 | 278.2 | 844 | 2.50E+15 | 283.8 | 328.7 | 728.9 | 7.49E−11 |
| Run 3 | 0.3 | 0.55 | 290 | 0.00018 | 1.00E−16 | 278.2 | 1392 | 2.50E+15 | 286.2 | 843.5 | 442 | 2.96E−11 |
| Run 4 | 0.45 | 0.55 | 290 | 6.98E−05 | 1.00E−16 | 278.2 | 3584 | 2.50E+15 | 288.5 | 1358 | 171.6 | 1.81E−11 |
| Run 5 | 0.05 | 0.7 | 290 | | | | | | | | | |
| Run 6 | 0.15 | 0.7 | 290 | 0.000371 | 1.00E−16 | 278.2 | 674.5 | 2.50E+15 | 282.3 | 328.7 | 912 | 7.49E−11 |
| Run 7 | 0.3 | 0.7 | 290 | 0.000261 | 1.00E−16 | 278.2 | 956.6 | 2.50E+15 | 284.5 | 843.5 | 643.1 | 2.92E−11 |
| Run 8 | 0.45 | 0.7 | 290 | 0.000159 | 1.00E−16 | 278.2 | 1577 | 2.50E+15 | 286.7 | 1358 | 390.1 | 1.81E−11 |
| Run 9 | 0.05 | 0.85 | 290 | | | | | | | | | |
| Run 10 | 0.15 | 0.85 | 290 | 0.000435 | 1.00E−16 | 278.2 | 575.2 | 2.50E+15 | 280.9 | 328.7 | 1069 | 7.49E−11 |
| Run 11 | 0.3 | 0.85 | 290 | 0.000331 | 1.00E−16 | 278.2 | 755.3 | 2.50E+15 | 283.1 | 843.5 | 814.5 | 2.87E−11 |
| Run 12 | 0.45 | 0.85 | 290 | 0.000234 | 1.00E−16 | 278.2 | 1070 | 2.50E+15 | 285.1 | 1358 | 574.8 | 1.81E−11 |
| Run 13 | 0.05 | 1 | 290 | | | | | | | | | |
| Run 14 | 0.15 | 1 | 290 | 0.00049 | 1.00E−16 | 278.2 | 509.8 | 2.50E+15 | 279.8 | 328.7 | 1207 | 7.49E−11 |
| Run 15 | 0.3 | 1 | 290 | 0.000391 | 1.00E−16 | 278.2 | 638.7 | 2.50E+15 | 281.9 | 843.5 | 963.2 | 2.92E−11 |
| Run 16 | 0.45 | 1 | 290 | 0.000298 | 1.00E−16 | 278.2 | 838 | 2.50E+15 | 283.8 | 1358 | 734.1 | 1.81E−11 |
| Run 17 | 0.05 | 0.55 | 300 | 0.000539 | 1.00E−16 | 278.2 | 463.7 | 2.50E+15 | 288.5 | 1244 | 1314 | 1.96E−11 |
| Run 18 | 0.15 | 0.55 | 300 | 0.000416 | 1.00E−16 | 278.2 | 600.4 | 2.50E+15 | 291.1 | 1856 | 1015 | 1.31E−11 |
| Run 19 | 0.3 | 0.55 | 300 | 0.000248 | 0.00013 | 278.2 | 1010 | 1922 | 294.7 | 2773 | 603.2 | 7.494 |
| Run 20 | 0.45 | 0.55 | 300 | 9.45E−05 | 0.000495 | 278.2 | 2647 | 505.2 | 298 | 3691 | 230.2 | 5.237 |
| Run 21 | 0.05 | 0.7 | 300 | 0.000627 | 1.00E−16 | 278.2 | 398.9 | 2.50E+15 | 286.7 | 1244 | 1527 | 1.96E−11 |
| Run 22 | 0.15 | 0.7 | 300 | 0.000512 | 1.00E−16 | 278.2 | 488.3 | 2.50E+15 | 289.1 | 1856 | 1248 | 1.31E−11 |
| Run 23 | 0.3 | 0.7 | 300 | 0.000354 | 0.00013 | 278.2 | 705.5 | 1922 | 292.5 | 2773 | 863.6 | 8.363 |
| Run 24 | 0.45 | 0.7 | 300 | 0.000212 | 0.000495 | 278.2 | 1182 | 505.2 | 295.5 | 3691 | 515.4 | 9.783 |
| Run 25 | 0.05 | 0.85 | 300 | 0.000701 | 1.00E−16 | 278.2 | 356.7 | 2.50E+15 | 285.2 | 1244 | 1708 | 1.96E−11 |
| Run 26 | 0.15 | 0.85 | 300 | 0.000592 | 1.00E−16 | 278.2 | 422 | 2.50E+15 | 287.5 | 1856 | 1444 | 1.31E−11 |
| Run 27 | 0.3 | 0.85 | 300 | 0.000443 | 0.00013 | 278.2 | 564 | 1922 | 290.6 | 2773 | 1080 | 8.839 |
| Run 28 | 0.45 | 0.85 | 300 | 0.000308 | 0.000495 | 278.2 | 811.4 | 505.2 | 293.5 | 3691 | 750.9 | 12.54 |
| Run 29 | 0.05 | 1 | 300 | 0.000765 | 1.00E−16 | 278.2 | 326.9 | 2.50E+15 | 283.8 | 1244 | 1864 | 1.96E−11 |
| Run 30 | 0.15 | 1 | 300 | 0.000661 | 1.00E−16 | 278.2 | 378 | 2.50E+15 | 286 | 1856 | 1612 | 1.31E−11 |
| Run 31 | 0.3 | 1 | 300 | 0.000519 | 0.00013 | 278.2 | 481.6 | 1922 | 289.1 | 2773 | 1265 | 9.142 |
| Run 32 | 0.45 | 1 | 300 | 0.00039 | 0.000495 | 278.2 | 641 | 505.2 | 291.8 | 3691 | 950.5 | 14.4 |
| Run 33 | 0.05 | 0.55 | 310 | 0.000722 | 1.00E−16 | 278.2 | 346.3 | 2.50E+15 | 294.4 | 2512 | 1742 | 9.61E−12 |
| Run 34 | 0.15 | 0.55 | 310 | 0.000548 | 4.18E−05 | 278.2 | 456.6 | 5976 | 298.2 | 3556 | 1321 | 2.638 |
| Run 35 | 0.3 | 0.55 | 310 | 0.000318 | 0.000664 | 278.2 | 785.4 | 376.7 | 303.2 | 5122 | 768.2 | 10.14 |
| Run 36 | 0.45 | 0.55 | 310 | 0.000119 | 0.001286 | 278.2 | 2093 | 194.5 | 307.5 | 6688 | 288.3 | 3.944 |
| Run 37 | 0.05 | 0.7 | 310 | 0.000827 | 1.00E−16 | 278.2 | 302.4 | 2.50E+15 | 292.2 | 2512 | 1995 | 9.61E−12 |
| Run 38 | 0.15 | 0.7 | 310 | 0.000664 | 4.18E−05 | 278.2 | 376.4 | 5976 | 295.8 | 3556 | 1603 | 2.671 |
| Run 39 | 0.3 | 0.7 | 310 | 0.000451 | 0.000664 | 278.2 | 554.9 | 376.7 | 300.4 | 5122 | 1087 | 12.64 |
| Run 40 | 0.45 | 0.7 | 310 | 0.000265 | 0.001286 | 278.2 | 944.1 | 194.5 | 304.4 | 6688 | 639.1 | 7.924 |
| Run 41 | 0.05 | 0.85 | 310 | 0.000914 | 1.00E−16 | 278.2 | 273.5 | 2.50E+15 | 290.4 | 2512 | 2206 | 9.61E−12 |
| Run 42 | 0.15 | 0.85 | 310 | 0.000761 | 4.18E−05 | 278.2 | 328.6 | 5976 | 293.8 | 3556 | 1836 | 2.691 |
| Run 43 | 0.3 | 0.85 | 310 | 0.000559 | 0.000664 | 278.2 | 447.4 | 376.7 | 298.1 | 5122 | 1348 | 14.29 |
| Run 44 | 0.45 | 0.85 | 310 | 0.000383 | 0.001286 | 278.2 | 652.7 | 194.5 | 301.9 | 6688 | 924.4 | 10.65 |
| Run 45 | 0.05 | 1 | 310 | 0.000989 | 1.00E−16 | 278.2 | 252.8 | 2.50E+15 | 288.9 | 2512 | 2387 | 9.61E−12 |
| Run 46 | 0.15 | 1 | 310 | 0.000843 | 4.18E−05 | 278.2 | 296.7 | 5976 | 292.1 | 3556 | 2033 | 2.705 |
| Run 47 | 0.3 | 1 | 310 | 0.00065 | 0.000664 | 278.2 | 384.7 | 376.7 | 296.3 | 5122 | 1568 | 15.47 |
| Run 48 | 0.45 | 1 | 310 | 0.000482 | 0.001286 | 278.2 | 518.6 | 194.5 | 299.9 | 6688 | 1163 | 12.65 |
| Run 49 | 0.05 | 0.55 | 320 | 0.00092 | 1.00E−16 | 278.2 | 271.7 | 2.50E+15 | 299.9 | 3833 | 2198 | 6.23E−12 |
| Run 50 | 0.15 | 0.55 | 320 | 0.000684 | 0.000458 | 278.2 | 365.6 | 546.1 | 305.2 | 5546 | 1634 | 11.81 |
| Run 51 | 0.3 | 0.55 | 320 | 0.00039 | 0.001477 | 278.2 | 641.5 | 169.2 | 311.7 | 8116 | 931.2 | 9.078 |
| Run 52 | 0.45 | 0.55 | 320 | 0.000145 | 0.002497 | 278.2 | 1730 | 100.1 | 317 | 10686 | 345.3 | 3.054 |
| Run 53 | 0.05 | 0.7 | 320 | 0.001041 | 1.00E−16 | 278.2 | 240.1 | 2.50E+15 | 297.4 | 3833 | 2488 | 6.23E−12 |
| Run 54 | 0.15 | 0.7 | 320 | 0.000822 | 0.000458 | 278.2 | 304.3 | 546.1 | 302.3 | 5546 | 1963 | 12.66 |
| Run 55 | 0.3 | 0.7 | 320 | 0.000547 | 0.001477 | 278.2 | 456.7 | 169.2 | 308.4 | 8116 | 1308 | 11.76 |
| Run 56 | 0.45 | 0.7 | 320 | 0.000318 | 0.002497 | 278.2 | 785.1 | 100.1 | 313.3 | 10686 | 760.9 | 6.315 |
| Run 57 | 0.05 | 0.85 | 320 | 0.001141 | 1.00E−16 | 278.2 | 219 | 2.50E+15 | 295.3 | 3833 | 2727 | 6.23E−12 |
| Run 58 | 0.15 | 0.85 | 320 | 0.000934 | 0.000458 | 278.2 | 267.6 | 546.1 | 300 | 5546 | 2232 | 13.24 |
| Run 59 | 0.3 | 0.85 | 320 | 0.000675 | 0.001477 | 278.2 | 370.3 | 169.2 | 305.7 | 8116 | 1613 | 13.64 |
| Run 60 | 0.45 | 0.85 | 320 | 0.000459 | 0.002497 | 278.2 | 545.2 | 100.1 | 310.4 | 10686 | 1096 | 8.662 |
| Run 61 | 0.05 | 1 | 320 | 0.001226 | 1.00E−16 | 278.2 | 203.9 | 2.50E+15 | 293.6 | 3833 | 2930 | 6.23E−12 |
| Run 62 | 0.15 | 1 | 320 | 0.001029 | 0.000458 | 278.2 | 243 | 546.1 | 298 | 5546 | 2458 | 13.65 |
| Run 63 | 0.3 | 1 | 320 | 0.000782 | 0.001477 | 278.2 | 319.8 | 169.2 | 303.5 | 8116 | 1868 | 15.05 |
| Run 64 | 0.45 | 1 | 320 | 0.000575 | 0.002497 | 278.2 | 434.7 | 100.1 | 308.1 | 10686 | 1374 | 10.45 |

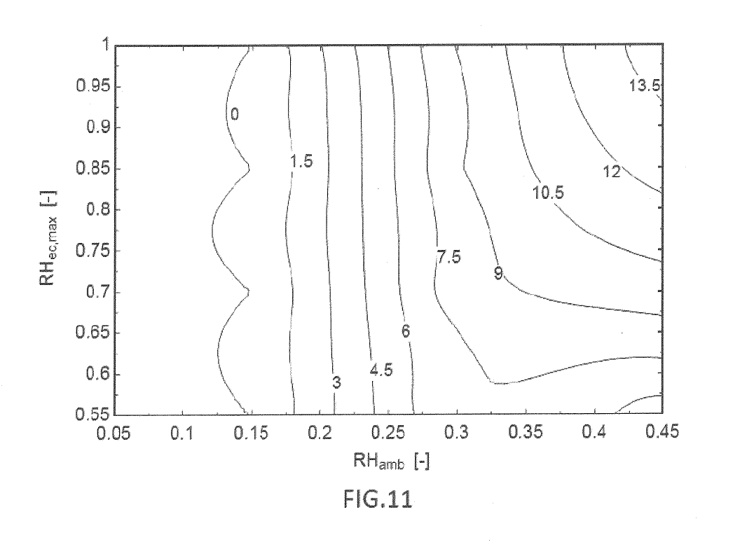

Graphs representing operation in evaporative cooling mode at three fixed temperatures are provided in FIGS. 11 (fixed temperature=300 Kelvin), 12 (fixed temperature=310 Kelvin) and 13 (fixed temperature=320 Kelvin). In each graph, the y-axis presents the output humidity of the air in evaporative cooling mode. The x-axis represents the ambient humidity. The data show that at ambient temperatures ranging between 300 and 320 Kelvin, the systems provided by the present disclosure show up to a 13.5% improvement of overall thermal load, as compared to the baseline configuration, using the evaporative cooling methodology described herein. The data provide proof that evaporative cooling is an effective means of reducing the temperature of the interior cabin of a vehicle under a range of ambient conditions.

While various aspects and embodiments have been discussed above, those of skill in the art will recognize certain modifications, permutations, additions and sub combinations thereof. It is therefore intended that the following appended claims and claims hereafter introduced are interpreted to include all such modifications, permutations, additions and sub-combinations as are within their true spirit and scope.

What is claimed is:

1. A method of cooling the interior cabin of a vehicle, comprising:
operating the vehicle's air conditioning (A/C) system, while allowing water condensate to accumulate on the surface of the A/C evaporator until the occurrence of a first event; and
altering or disabling the refrigeration circuit of the A/C system to turn off the flow of refrigerant while the evaporator blower remains in operation, thereby cooling the air flowing through the evaporator by evaporative cooling.

2. The method claim 1, wherein evaporative cooling occurs until the water condensate is depleted.

3. The method of claim 2, wherein operation of the A/C system is resumed upon depletion of the water condensate.

4. The method of claim 1, wherein the A/C system is operated until water condensate accumulates to a level that is less than the full capacity of the evaporator.

5. The method of claim 1, wherein the A/C system is operated until water condensate accumulates to a level that is equal to the full capacity of the evaporator.

6. The method of claim 1, wherein the A/C system is operated until water condensate accumulates to a level that is greater than the capacity of the evaporator.

7. The method of claim 1, wherein the first event is selected from an idle-off period for the vehicle, a point where the vehicle is at a complete stop, a point where the vehicle is rapidly accelerating, a point where the vehicle is coasting, a point where the vehicle is slowing down, and meeting a target accumulated condensate mass in the evaporator.

8. The method of claim 1, wherein the first event is selected from an idle-off period for the vehicle, a point where the vehicle is rapidly accelerating, and meeting a target accumulated condensate mass in the evaporator. In some embodiments, the first target event is an idle-off period for the vehicle.

9. The method of claim 1, wherein the first event is a point where the vehicle is rapidly accelerating.

10. The method of claim 1, wherein the first event is meeting a target accumulated condensate mass in the evaporator.

11. A method of cooling the interior cabin of a vehicle, comprising:
performing climate conditioning of the interior cabin of the vehicle using a typical air conditioning (A/C) system op for a specified duration to allow water condensate to accumulate on the surface of the evaporator until a first target event occurs;
switching the system operation to evaporative cooling of the air passing through the evaporator by altering or disabling the A/C refrigeration circuit, while the evaporator blower remains in operation;
allowing evaporative cooling to continue for a period of time sufficient to evaporate an amount of the condensate, cooling the air being brought into the system by evaporative cooling; and
switching operation back to typical A/C system operation based on the occurrence of a second target event.

12. The method of claim 11, wherein typical A/C system operation occurs while bringing a large enough outside air fraction into the A/C system to allow a target quantity of condensate to accumulate in the evaporator.

13. The method of claim 12, wherein the target quantity of condensate is selected from a level that is less than the full capacity of the evaporator, a level that is equal to the full capacity of the evaporator and a level that is greater than the capacity of the evaporator.

14. The method of claim 12, wherein, upon switching to evaporative cooling, the outside air fraction is changed to a different set point selected from completely recycled air and partially recycled air mixed with outside air.

15. The method of claim 11, wherein the first target event is selected from an idle-off period for the vehicle, a point where the vehicle is at a complete stop, a point where the vehicle is rapidly accelerating, a point where the vehicle is coasting, a point where the vehicle is slowing down, and meeting a target accumulated condensate mass in the evaporator.

16. The method of claim 11, wherein the second target event is selected from cessation of an idle-off period for the vehicle, a point where the vehicle is slowly accelerating, a point where the vehicle is coasting, and meeting a target reduction of condensate mass in the evaporator from evaporative cooling.

17. The method of claim 11, wherein the second target event is selected from cessation of an idle-off period for the vehicle and meeting a target reduction of condensate mass in the evaporator from evaporative cooling.

18. The method of claim 11, wherein the second target event is cessation of an idle-off period for the vehicle.

19. The method of claim 11, wherein the second target event is meeting a target reduction of condensate mass in the evaporator from evaporative cooling.
